(19) United States
(12) Patent Application Publication
(10) Pub. No.: US 2018/0260285 A1
(43) Pub. Date: Sep. 13, 2018

(54) NON-TRANSITORY COMPUTER-READABLE STORAGE MEDIUM AND DATA PROCESSING APPARATUS AND METHOD

(71) Applicant: FUJITSU LIMITED, Kawasaki-shi (JP)

(72) Inventors: Yoshinori Arai, Kawasaki (JP); TAKEHIRO IDE, Mishima (JP)

(73) Assignee: FUJITSU LIMITED, Kawasaki-shi (JP)

(21) Appl. No.: 15/912,714

(22) Filed: Mar. 6, 2018

(30) Foreign Application Priority Data
Mar. 9, 2017 (JP) 2017-045139

(51) Int. Cl. G06F 11/14; G06F 9/54; H04L 12/58

(52) U.S. Cl. CPC G06F 11/1464; H04L 51/18; G06F 9/546; G06F 11/1471

(57) ABSTRACT

A non-transitory computer-readable storage medium storing a program that causes a computer to execute a process including storing a first and second received data into a first storage device, the first received data having been received prior to the second received data, generating a first and second processed data corresponding to the first and second received data, the second processed data being to be transmitted after a transmission of the first processed data, storing the second processed data into a second storage device when a rollback relating to the first received data is detected in a specified period, the specified period being a period after the second processed data has been generated and before the second processed data is transmitted, and transmitting the second processed data after the rollback, the second processed data being not regenerated by retrieving the stored second processed data from the second storage device.

### CROSS-REFERENCE TO RELATED APPLICATION

This application is based upon and claims the benefit of priority of the prior Japanese Patent Application No. 2017-45139, filed on Mar. 9, 2017, the entire contents of which are incorporated herein by reference.

### FIELD

The embodiments discussed herein are related to a non-transitory computer-readable storage medium and data processing apparatus and method.

### BACKGROUND

A business operator that offers services to users (hereinafter, referred to also as business operator simply) constructs and operates a business system according to the use purpose, for example, in order to offer various kinds of services to the users. In such a business system, a message queue system that manages execution requests (messages) of processing transmitted and received among a plurality of information processing apparatuses is included, for example.

The message queue system is a system in which messages transmitted by each information processing apparatus to another information processing apparatus are stored in a queue, for example. For example, if each information processing apparatus that cooperates with the message queue system transmits a message to another information processing apparatus, the information processing apparatus transmits the message only to the message queue system (information processing apparatus on which the message queue system operates). Then, the message queue system that has received the message transmits the message to the information processing apparatus (for example, a plurality of information processing apparatuses) that is the transmission destination of the received message. Due to this, even in the case of transmitting a message to a plurality of information processing apparatuses, each information processing apparatus does not need to transmit the message to all information processing apparatuses that are the transmission destinations. For this reason, it becomes possible for the message queue system to suppress the processing load of each information processing apparatus that transmits and receives messages, for example (for example, refer to Japanese Laid-open Patent Publications No. 2014-38564, No. 06-28199, and No. 2010-176303).

### SUMMARY

According to an aspect of the embodiments, a non-transitory computer-readable storage medium storing a program that causes a computer to execute a process, the process including storing a first received data and a second received data into a first storage device, the first received data having been received prior to the second received data, generating a first processed data corresponding to the first received data and a second processed data corresponding to the second received data, the second processed data being to be transmitted to at least one information processing apparatus other than the computer after a transmission of the first processed data, storing the second processed data into a second storage device when a rollback relating to the first received data is detected in a specified period, the specified period being a period after the second processed data has been generated and before the second processed data is transmitted, and transmitting the second processed data stored in the second storage device after the rollback has been detected and the first processed data has been transmitted, the second processed data being not regenerated by retrieving the stored second processed data from the second storage device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an overall configuration of an information processing system;

FIG. 2 is a diagram for explaining operation in a relay apparatus;

FIG. 3 is a diagram for explaining operation in a relay apparatus;

FIG. 4 is a diagram for explaining operation in a relay apparatus;

FIG. 5 is a diagram for explaining operation in a relay apparatus;

FIG. 6 is a diagram for explaining operation in a relay apparatus;

FIG. 7 is a diagram for explaining a hardware configuration of a relay apparatus;

FIG. 8 is a functional block diagram of the relay apparatus in FIG. 7;

FIG. 9 is a block diagram of pieces of information the relay apparatus in FIG. 7 includes;

FIG. 10 is a flowchart diagram for explaining outline of data management processing in a first embodiment;

FIG. 11 is a flowchart diagram for explaining the outline of the data management processing in the first embodiment;

FIG. 12 is a diagram for explaining the outline of the data management processing in the first embodiment;

FIG. 13 is a diagram for explaining the outline of the data management processing in the first embodiment;

FIG. 14 is a diagram for explaining the outline of the data management processing in the first embodiment;

FIG. 15 is a flowchart diagram for explaining details of the data management processing in the first embodiment;

FIG. 16 is a flowchart diagram for explaining the details of the data management processing in the first embodiment;

FIG. 17 is a flowchart diagram for explaining the details of the data management processing in the first embodiment;

FIG. 18 is a diagram for explaining a concrete example of order-of-reception information;

FIG. 19 is a diagram for explaining a concrete example of identification information;

FIG. 20 is a diagram for explaining a concrete example of identification information;

FIG. 21 is a diagram for explaining a concrete example of identification information;

FIG. 22 is a flowchart diagram for explaining details of data management processing in a second embodiment;

FIG. 23 is a flowchart diagram for explaining the details of the data management processing in the second embodiment;

FIG. 24 is a diagram for explaining the details of the data management processing in the second embodiment; and

FIG. 25 is a diagram for explaining the details of the data management processing in the second embodiment.

### DESCRIPTION OF EMBODIMENTS

In the above-described message queue system, transmission of messages to the respective information processing apparatuses is carried out in accordance with the order of reception of the messages in a queue, for example. For this reason, for example, even if manipulation processing of a message (for example, conversion of the character code) executed before transmission of the message is executed regarding plural messages concurrently, the message queue system carries out control to cause the messages to be transmitted in accordance with the order of reception of the messages.

Furthermore, for example, if an abnormality occurs at the time of transmission of messages, the message queue system returns, to the queue, all messages later in the order of reception than the message about which the abnormality has occurred (hereinafter, this will be referred to also as rollback). This allows the message queue system to keep the messages later in the order of reception than the message about which the abnormality has occurred from being transmitted to the information processing apparatus of the transmission destination earlier than the message about which the abnormality has occurred.

Here, the messages later in the order of reception than the message about which the abnormality has occurred are returned to the queue in the state when the messages are transmitted from the information processing apparatus of the transmission source (state when the messages are stored in the queue first) irrespective of the progress of the manipulation processing, for example. However, the queue that stores the messages does not have a function of storing additional information or the like of the messages in some cases. For this reason, in this case, it is difficult for the message queue system to cause the queue to store information that associates the message returned to the queue (message in the state of being stored in the queue first) with the message in the state resulting from completion of the manipulation processing (hereinafter, referred to also as manipulated message). Therefore, in this case, it is difficult for the message queue system to identify the manipulated message generated before the message is returned to the queue (manipulated message generated from the message returned to the queue) when retransmitting the message returned to the queue. For this reason, in some cases, the message queue system generates the manipulated message again every time a message is returned to the queue in association with the occurrence of rollback.

Therefore, in one aspect, the embodiments discussed herein intend to provide data processing program, apparatus, and method that enable suppression of redoing of processing attributed to rollback.

[Configuration of Message Queue System]

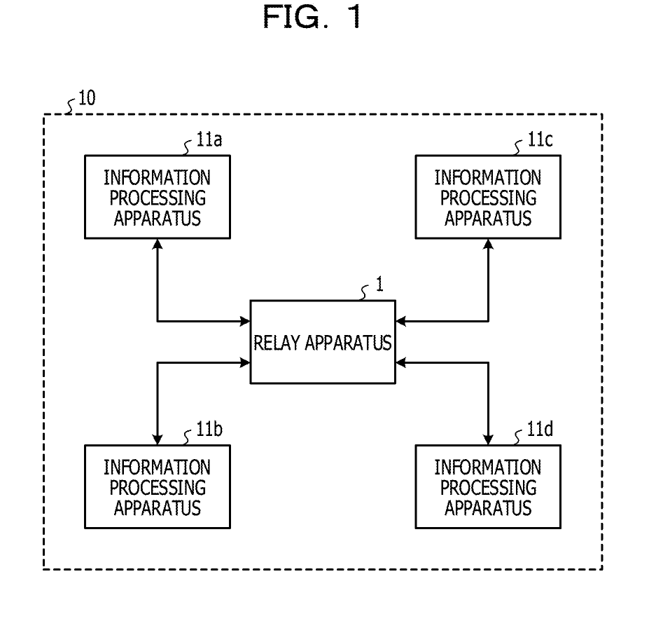

FIG. 1 is a diagram illustrating an overall configuration of an information processing system. A message queue system 10 (hereinafter, referred to also as information processing system 10) illustrated in FIG. 1 includes a relay apparatus 1 (hereinafter, referred to also as data processing apparatus 1) and information processing apparatuses 11a, 11b, 11c, and 11d (hereinafter, these apparatuses will be referred to also as information processing apparatus 11 collectively). The message queue system 10 may be a system including four or more information processing apparatuses 11.

The information processing apparatuses 11a, 11b, 11c, and 11d each include one or more physical machines, for example, and a business system for a business operator to offer services to users operates on each of the information processing apparatuses 11a, 11b, 11c, and 11d.

The relay apparatus 1 receives messages transmitted by the information processing apparatus 11 to another information processing apparatus 11 and temporarily stores the messages in a queue. Then, the relay apparatus 1 extracts the messages stored in the queue in the order of storing in the queue and sequentially transmits the messages to the information processing apparatus 11 of the transmission destination, for example.

Furthermore, the relay apparatus 1 executes manipulation processing for a message after the message is extracted from the queue and before the message is transmitted to the information processing apparatus 11 of the transmission destination, for example. Operation in the relay apparatus 1 will be described below.

[Operation in Relay Apparatus]

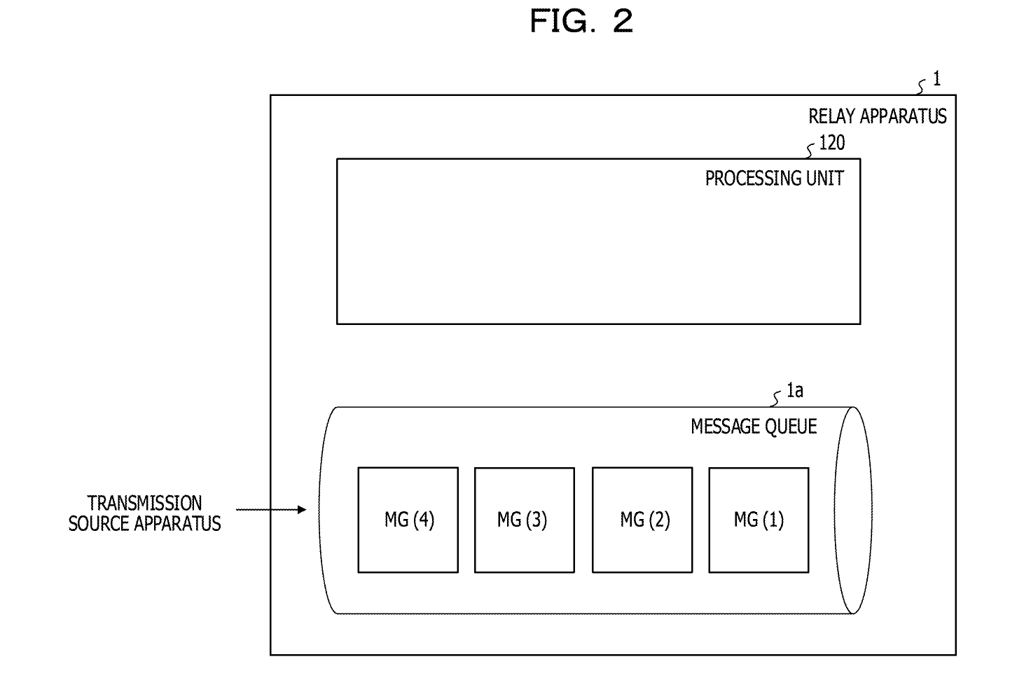

FIG. 2 to FIG. 6 are diagrams for explaining the operation in the relay apparatus 1. As illustrated in FIG. 2, the relay apparatus 1 stores messages transmitted from a transmission source apparatus (information processing apparatus 11 of the transmission source) to a message queue 1a (hereinafter, referred to also as queue 1a simply). For example, in the example illustrated in FIG. 2, messages (1) to (4) (hereinafter, referred to also as MG (1) to MG (4), respectively) are stored in the queue 1a.

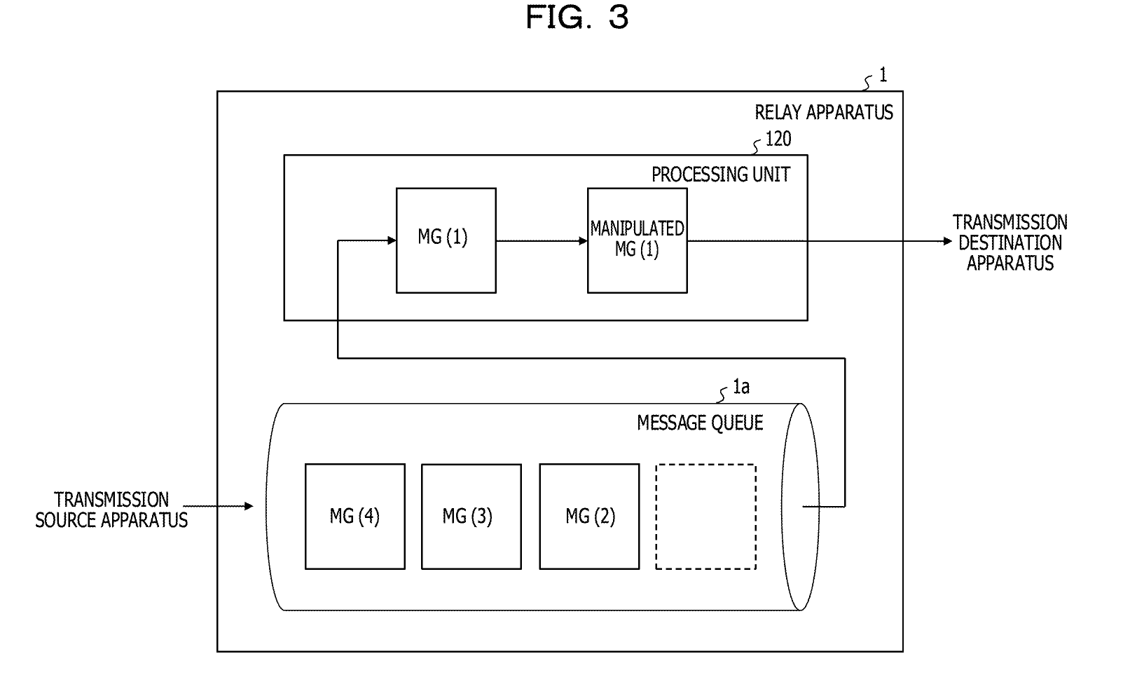

Then, as illustrated in FIG. 3, a processing unit 120 of the relay apparatus 1 extracts MG (1), which is the message stored in the queue 1a first, among the messages stored in the queue 1a and executes manipulation processing of the message. Then, the processing unit 120 transmits manipulated message (1) obtained by the execution of the manipulation processing for MG (1) (hereinafter, referred to also as manipulated MG (1)) to a transmission destination apparatus (information processing apparatus 11 of the transmission destination).

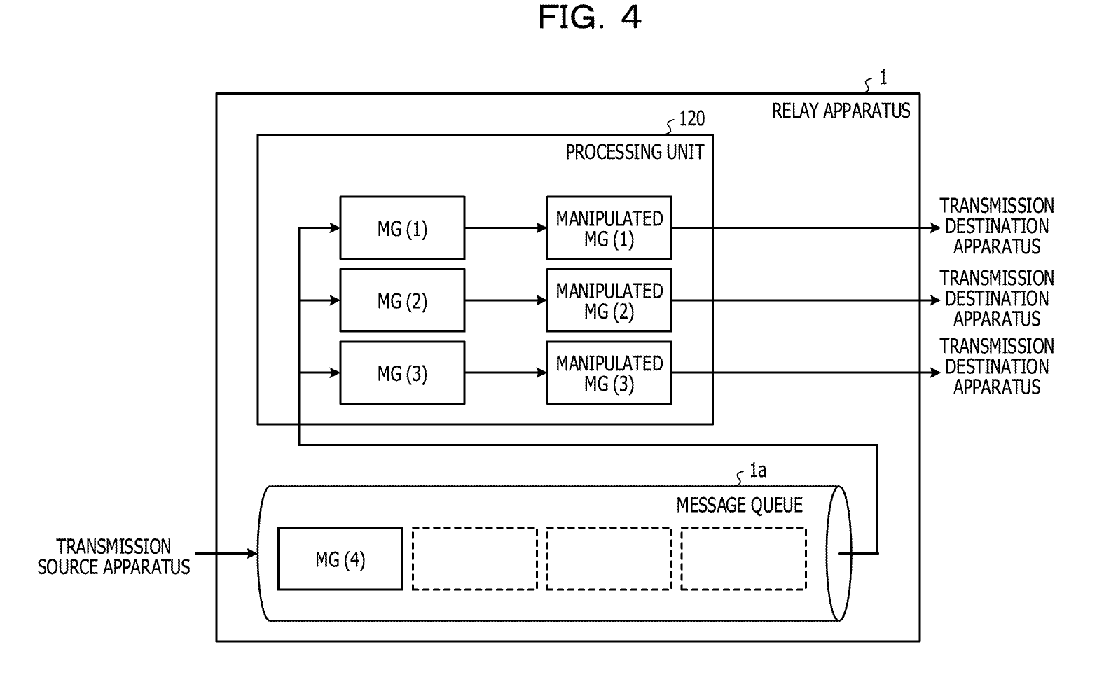

Furthermore, for example, as illustrated in FIG. 4, the relay apparatus 1 executes the manipulation processing of the message about plural messages concurrently under a condition that the relay apparatus 1 carries out the transmission of the messages to the transmission destination apparatus in accordance with the order of reception of the messages. For example, as illustrated in FIG. 4, the relay apparatus 1 concurrently executes the manipulation processing of MG (1), MG (2), and MG (3) among the messages stored in the queue 1a to generate manipulated MG (1), manipulated MG (2), and manipulated MG (3). This allows the relay apparatus 1 to efficiently execute the manipulation processing of the message. Then, the relay apparatus 1 transmits generated manipulated MG (1), manipulated MG (2), and manipulated MG (3) to the transmission destination apparatus in accordance with the order of reception in the queue 1a.

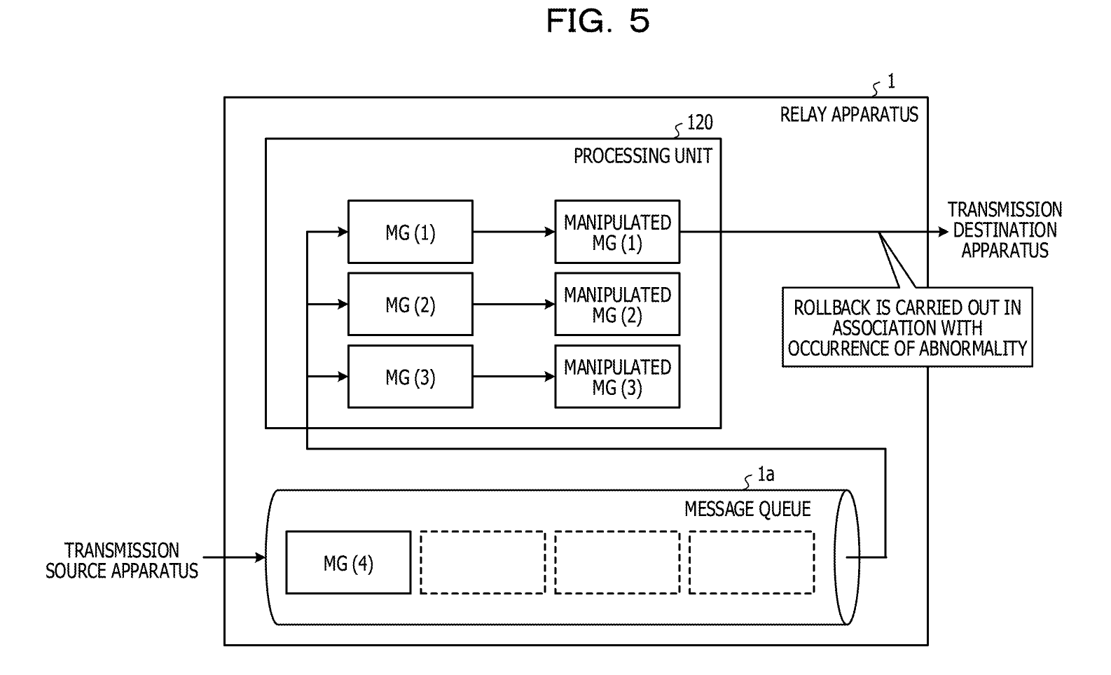

Furthermore, for example, if an abnormality occurs in the transmission of the messages, the relay apparatus 1 carries out rollback of the messages later in the order of reception than the message about which the abnormality has occurred as illustrated in FIG. 5 in some cases. In this case, the messages later in the order of reception than the message about which the abnormality has occurred are returned to the queue 1a in the state when the messages are transmitted from the information processing apparatus 11 of the transmission source (state when the messages are stored in the queue 1a first) irrespective of the progress of the manipulation processing and so forth.

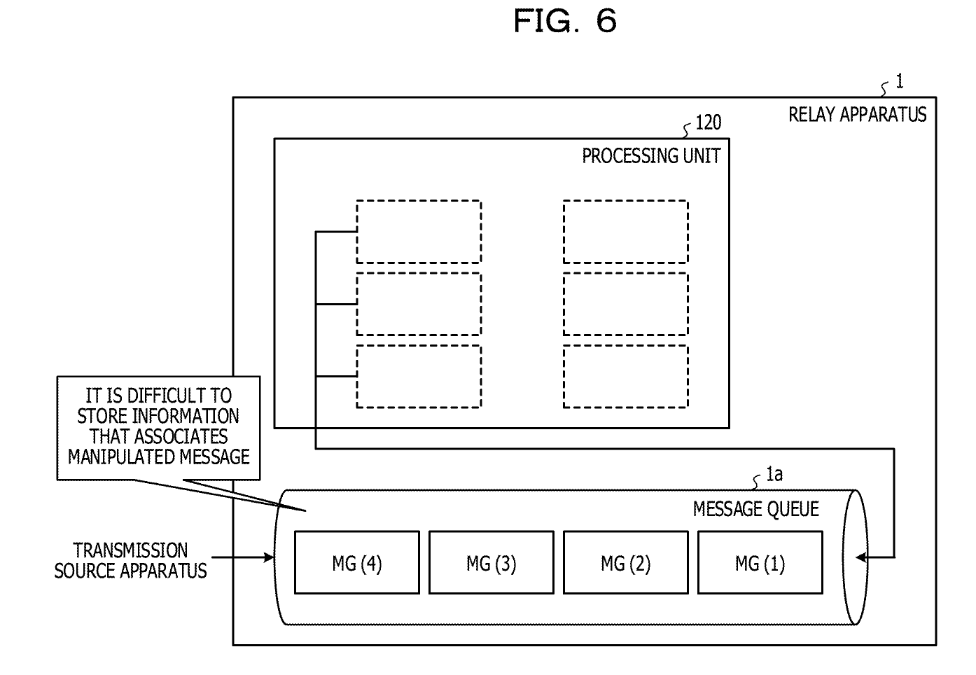

For example, as illustrated in FIG. 6, if rollback occurs attributed to an abnormality that has occurred at the time of transmission of manipulated MG (1), the relay apparatus 1 returns MG (1) to the queue 1a. Furthermore, in this case, the relay apparatus 1 returns MG (2) and MG (3) later than MG (1) in the order of reception to the queue 1a irrespective of the progress status of the manipulation processing for generating manipulated MG (2) and manipulated MG (3).

In this case, for example, if the queue 1a does not have a function of storing additional information of the message, it is difficult for the relay apparatus 1 to cause the queue 1a to store information for associating MG (1), MG (2), and MG (3) returned to the queue 1a in association with the rollback with manipulated MG (1), manipulated MG (2), and manipulated MG (3), respectively. For this reason, it is difficult for the relay apparatus 1 to identify manipulated MG (1) generated before the message is returned to the queue 1a when retransmitting manipulated MG (1), for example. Similarly, it is difficult for the relay apparatus 1 to identify manipulated MG (2) generated before the message is returned to the queue 1a when transmitting manipulated MG (2), for example. Therefore, in some cases, every time a message is returned to the queue 1a in association with the occurrence of rollback, the relay apparatus 1 executes the manipulation processing of the message again.

Therefore, in the present embodiment, the relay apparatus 1 associates plural messages (hereinafter, referred to also as data simply) received from the information processing apparatus 11 of the transmission source with the order of reception of each of the plural messages and stores the plural messages in a storing part, and generates a manipulated message (hereinafter, referred to also as manipulated data) of each of the plural messages. Then, the relay apparatus 1 transmits each of the generated manipulated messages to the transmission destination in accordance with the order of reception.

Thereafter, after generation of a manipulated message of a message (hereinafter, referred to also as specific message) included in the plural messages and before transmission of the manipulated message, the relay apparatus 1 detects rollback of another message that is associated with earlier order of reception than the specific message and is stored in the storing part. Then, when detecting the rollback, the relay apparatus 1 stores the manipulated message of the specific message in another storing part. In addition, the relay apparatus 1 associates identification information of the manipulated message of the specific message with the specific message and stores the identification information in the storing part.

For example, when receiving a message from the information processing apparatus 11 of the transmission source, the relay apparatus 1 stores the received message in a queue (storing part) that may store the identification information of the message. Furthermore, in the case of returning the specific message to the queue in association with the occurrence of rollback of the other message, the relay apparatus 1 returns the specific message in the state of being associated with the identification information of the manipulated message of the specific message to the queue that may store the identification information of the message. Furthermore, in this case, the relay apparatus 1 stores the manipulated message of the specific message in the other storing part different from the storing part to which the specific message is returned, for example.

Due to this, if the manipulated message of the specific message has been already generated in the case in which rollback of the other message has occurred, the relay apparatus 1 is allowed to return the specific message to the queue in the state of being associated with the manipulated message of the specific message. For this reason, if the manipulated message of the message stored in the queue has been already generated, the relay apparatus 1 is allowed to identify the manipulated message corresponding to a respective one of the messages by referring to the identification information stored in the queue. Therefore, it becomes possible for the relay apparatus 1 to keep the manipulated message from being repeatedly generated.

[Hardware Configuration of Relay Apparatus]

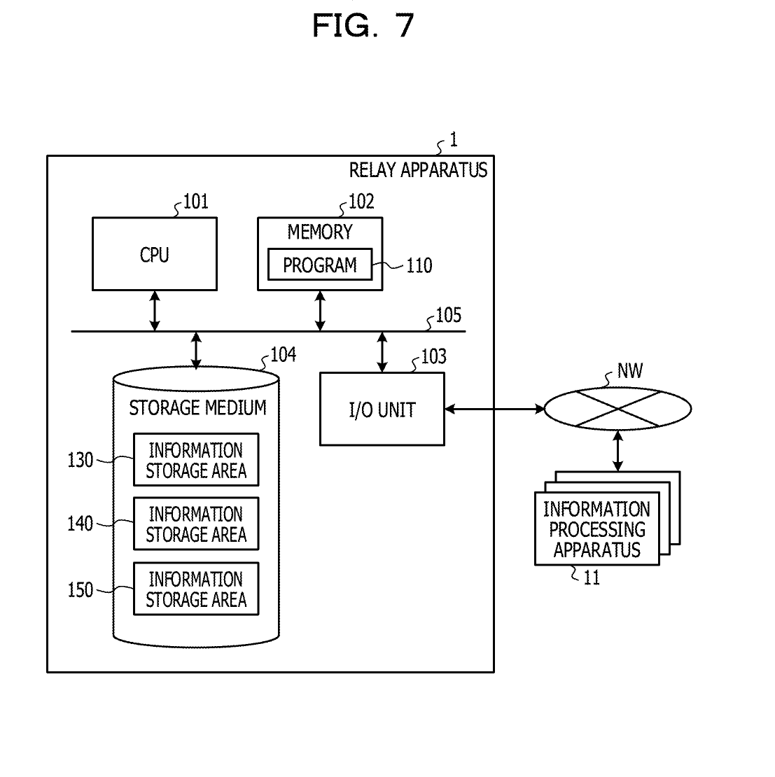

Next, the hardware configuration of the relay apparatus 1 will be described. FIG. 7 is a diagram for explaining the hardware configuration of the relay apparatus 1.

The relay apparatus 1 includes a central processing unit (CPU) 101 that is a processor, a memory 102, an external interface (input/output (I/O) unit) 103, and a storage medium (storage) 104. The respective units are coupled to each other through a bus 105.

The storage medium 104 stores, in a program storage area (not illustrated) in the storage medium 104, a program 110 (hereinafter, referred to also as data processing program 110) for executing processing of storing a message (data) transmitted by the information processing apparatus 11 to another information processing apparatus 11 (hereinafter, referred to also as data management processing).

As illustrated in FIG. 7, at the time of execution of the program 110, the CPU 101 loads the program 110 from the storage medium 104 into the memory 102 and executes the data management processing in cooperation with the program 110.

The storage medium 104 includes an information storage area 130 (hereinafter, referred to also as storing part 130 or first storing part 130) and an information storage area 140 (hereinafter, referred to also as storing part 140 or second storing part 140) that store information used when the data management processing is executed, for example. Furthermore, the storage medium 104 includes an information storage area 150 (hereinafter, referred to also as storing part 150 or third storing part 150) that stores information used when the data management processing is executed, for example.

The external interface 103 carries out communication with the information processing apparatus 11 through a network NW, for example.

[Software Configuration of Relay Apparatus]

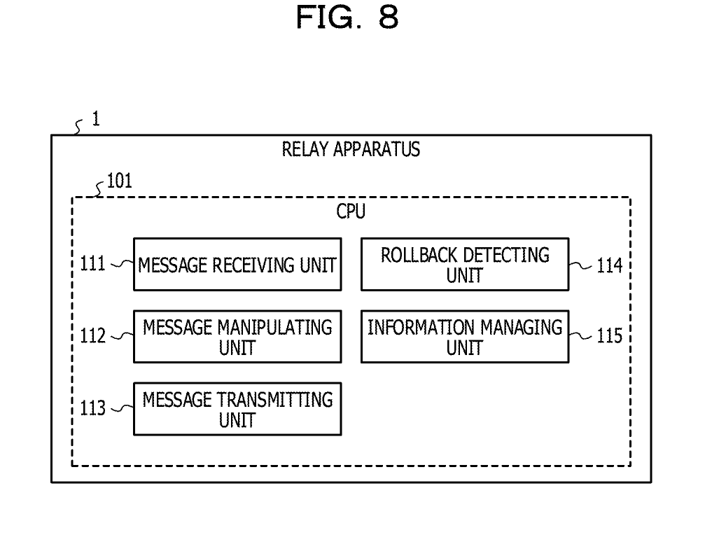

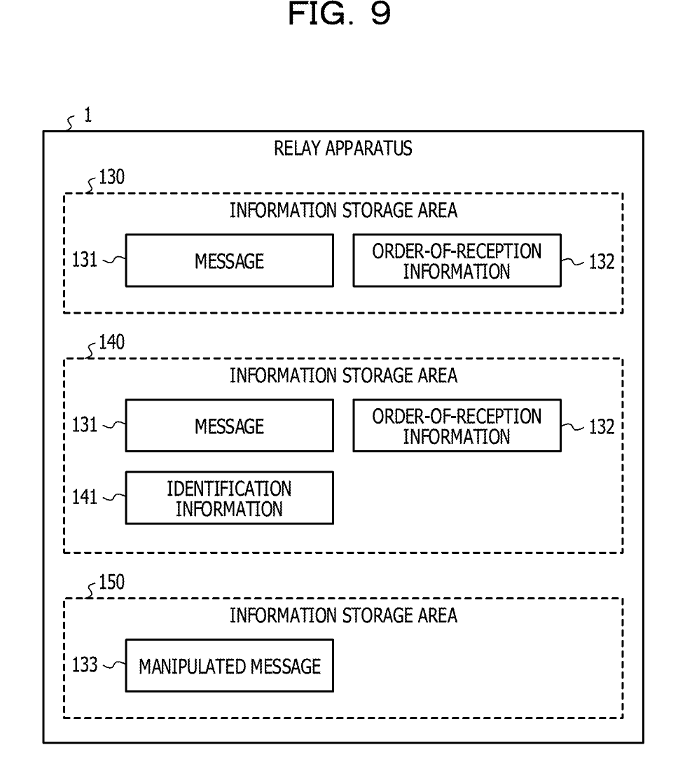

Next, the software configuration of the relay apparatus 1 will be described. FIG. 8 is a functional block diagram of the relay apparatus 1 in FIG. 7. Furthermore, FIG. 9 is a block diagram of pieces of information the relay apparatus 1 in FIG. 7 includes.

By cooperating with the program 110, the CPU 101 operates as a message receiving unit 111, a message manipulating unit 112, a message transmitting unit 113, a rollback detecting unit 114, and an information managing unit 115 as illustrated in FIG. 8.

Furthermore, as illustrated in FIG. 9, a message 131 and order-of-reception information 132 are stored in the information storage area 130. In addition, the message 131, the order-of-reception information 132, and identification information 141 are stored in the information storage area 140. Moreover, a manipulated message 133 is stored in the information storage area 150.

The message receiving unit 111 receives the message 131 transmitted from the information processing apparatus 11 of a transmission source. Then, the message receiving unit 111 associates the message 131 received from the information processing apparatus 11 of the transmission source with the order-of-reception information 132 that is information indicating the order of reception of each message 131 and stores the message 131 in the information storage area 130. Furthermore, the message receiving unit 111 associates the message 131 received from the information processing apparatus 11 of the transmission source with the order-of-reception information 132 and stores the message 131 also in the information storage area 140.

The information storage area 130 is a storing area in which the message 131 transmitted from the information processing apparatus 11 of the transmission source is stored first and is a storing area that does not store information other than the message 131 and the order-of-reception information 132 (for example, identification information 141), for example. Furthermore, the information storage area 140 is a storing area that may store information other than the message 131 and the order-of-reception information 132, for example. For example, the information storage area 130 is a storing area that is not managed by a business operator and therefore is a storing area that is difficult to modify or the like. Furthermore, the information storage area 140 is a storing area managed by a business operator and therefore is a storing area that may be modified or the like, for example.

For example, if the information storage area 130 does not store the identification information 141, the message receiving unit 111 stores the message 131 and the order-of-reception information 132 in the information storage area 140 capable of storing the identification information 141 in addition to the information storage area 130. Then, the message manipulating unit 112 extracts the message 131 from the information storage area 140 as described later. This enables the information managing unit 115 to store also the identification information 141 that associates the message 131 with the manipulated message 133 in the information storage area 140 when the message 131 is returned to the information storage area 140 in association with the occurrence of rollback as described later.

The message manipulating unit 112 extracts the message 131 stored in the information storage area 140 and manipulates the extracted message 131 to generate the message 131 that has been manipulated (hereinafter, referred to also as manipulated message 133). For example, the message manipulating unit 112 generates the manipulated message 133 by carrying out conversion of the character code for the message 131. The message manipulating unit 112 may refer to the order-of-reception information 132 and execute the manipulation processing sequentially from the message 131 that is the earliest in the order of reception, for example.

The message transmitting unit 113 refers to the order-of-reception information 132 and carries out transmission to the information processing apparatus 11 of the transmission destination sequentially from the manipulated message 133 of the message 131 that is the earliest in the order of reception.

If rollback of processing for the message 131 (manipulation processing or transmission processing of the message 131) extracted from the information storage area 140 occurs due to the occurrence of an abnormality in the processing for the message 131, the rollback detecting unit 114 detects the rollback. The rollback of processing for the message 131 is processing of returning, to the information storage area 140, the message 131 that has been extracted from the information storage area 140 and is being subjected to the processing and whose manipulated message 133 has not been transmitted to the information processing apparatus 11 of the transmission destination.

If the rollback detecting unit 114 detects rollback of processing for the message 131, the information managing unit 115 identifies the messages 131 later in the order of reception than the message 131 of the rollback target (hereinafter, referred to also as message 131a). Then, the information managing unit 115 identifies, among the identified messages 131, the message 131 in the state after the manipulated message 133 has been generated and before the manipulated message 133 is transmitted to the information processing apparatus 11 of the transmission destination (hereinafter, referred to also as message 131b).

Thereafter, the information managing unit 115 stores the manipulated message 133 of the identified message 131b in the information storage area 150. Furthermore, when returning the message 131b to the information storage area 140, the information managing unit 115 associates the identification information 141 for identifying the manipulated message 133 of the message 131b with the message 131b and stores the identification information 141 in the information storage area 140.

If the manipulated message 133 of the message 131a has been generated in the case in which rollback of processing for the message 131a is detected, the information managing unit 115 also stores the manipulated message 133 of the message 131a in the information storage area 150. Furthermore, in this case, when returning the message 131a to the information storage area 140, the information managing unit 115 associates the identification information 141 for identifying the manipulated message 133 of the message 131a with the message 131a and stores the identification information 141 in the information storage area 140.

### Outline of First Embodiment

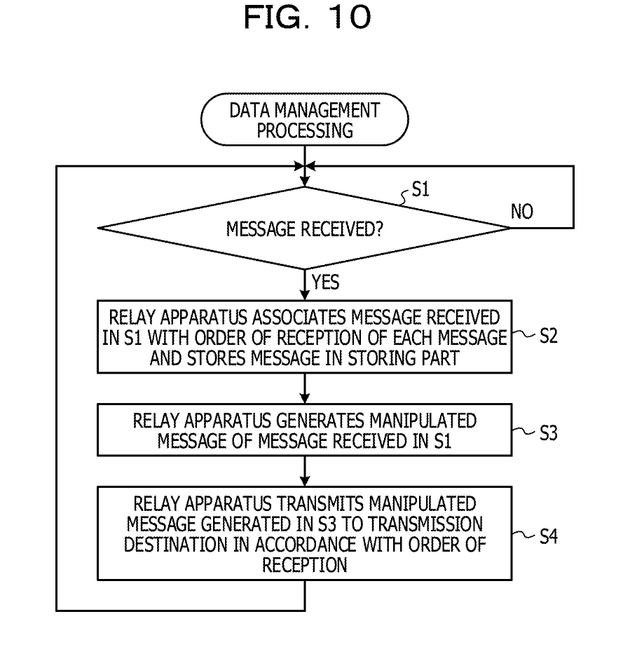

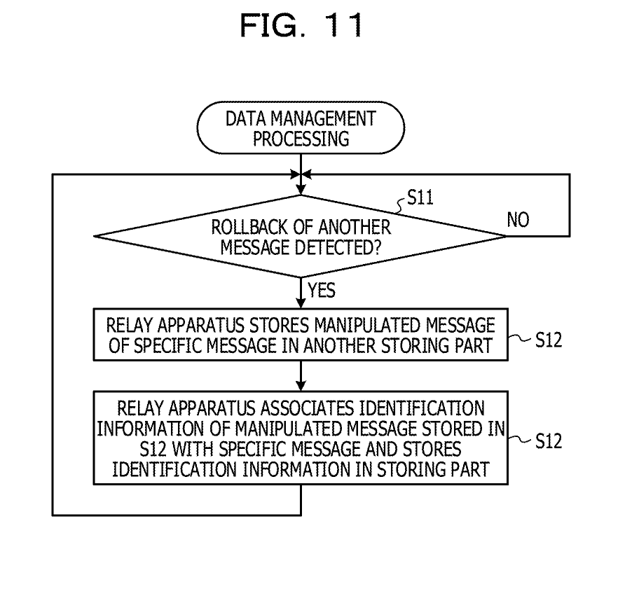

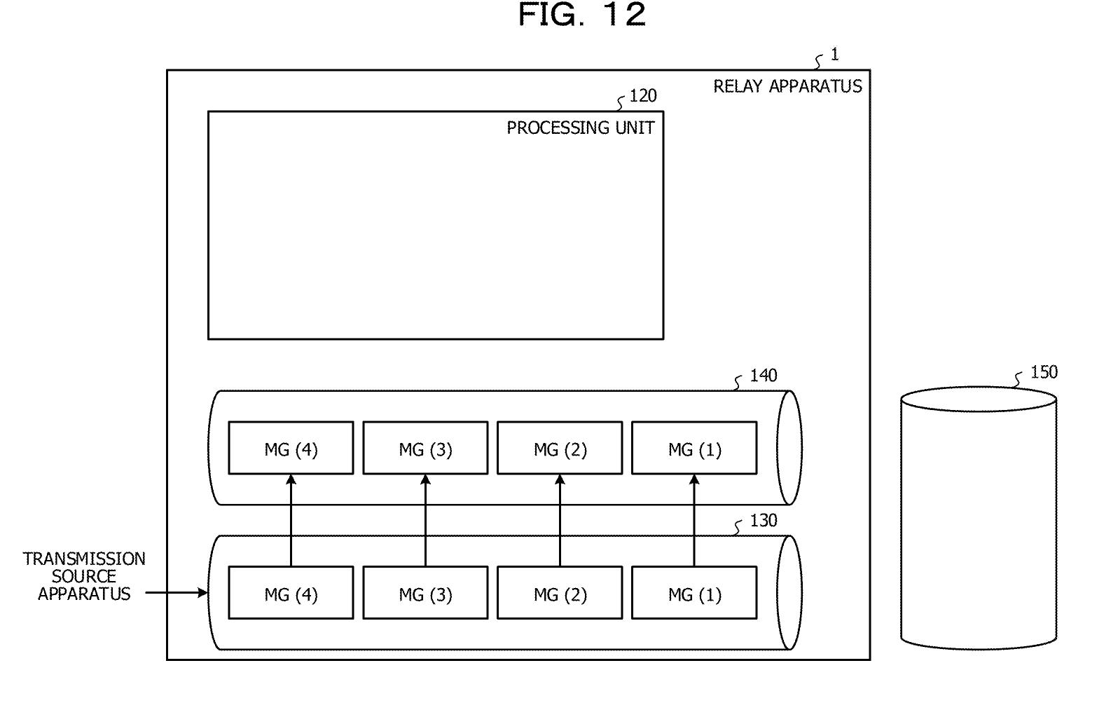

Next, the outline of a first embodiment will be described. FIG. 10 and FIG. 11 are flowchart diagrams for explaining the outline of the data management processing in the first embodiment. Furthermore, FIG. 12 to FIG. 14 are diagrams for explaining the outline of the data management processing in the first embodiment. The data management processing of FIG. 10 and FIG. 11 will be described with reference to FIG. 12 to FIG. 14.

As represented in FIG. 10, the relay apparatus 1 waits until receiving the message 131 from the information processing apparatus 11 of the transmission source (NO of S1). Then, if receiving the message 131 (YES of S1), the relay apparatus 1 associates the message 131 received in the processing of S1 with the order of reception of each message 131 and stores the message 131 in the information storage area 140 (S2). For example, as illustrated in FIG. 12, if the relay apparatus 1 stores MG (1) to MG (4) transmitted from the information processing apparatus 11 in the information storage area 130, the relay apparatus 1 stores MG (1) to MG (4) stored in the information storage area 130 also in the information storage area 140.

For example, the information storage area 130, in which the message transmitted from the information processing apparatus 11 of the transmission source is stored first, is an area that does not store additional information (for example, identification information 141) of the message in some cases. In this case, if a message extracted from the information storage area 130 is returned to the information storage area 130 in association with the occurrence of rollback, the information storage area 130 does not store the identification information 141 that is information in which the message 131 and the manipulated message 133 are associated. For this reason, the relay apparatus 1 is desired to generate the manipulated message 133 again every time rollback occurs.

Therefore, for example, if the message 131 received from the information processing apparatus 11 of the transmission source is stored in the information storage area 130, the relay apparatus 1 in the present embodiment stores the message 131 stored in the information storage area 130 in the information storage area 140 capable of storing the identification information 141. Then, the relay apparatus 1 extracts the message 131 from the information storage area 140 and executes manipulation processing and so forth of the message 131 as described later.

This allows the relay apparatus 1 to store the identification information 141 corresponding to the manipulated message 133 that has been already generated in the information storage area 140 when the message 131 is returned to the information storage area 140 in association with the occurrence of rollback. For this reason, when extraction of the message 131 returned to the information storage area 140 is carried out again, the relay apparatus 1 is allowed to identify the manipulated message 133 of the extracted message 131 by referring to the identification information 141. Therefore, it becomes possible for the relay apparatus 1 to keep generation of the same manipulated message 133 from being repeatedly carried out every time rollback occurs.

Then, the relay apparatus 1 generates the manipulated message 133 of the message 131 received in the processing of S1 (S3). Thereafter, the relay apparatus 1 transmits the manipulated message 133 generated in the processing of S3 to the information processing apparatus 11 of the transmission destination in accordance with the order of reception (S4).

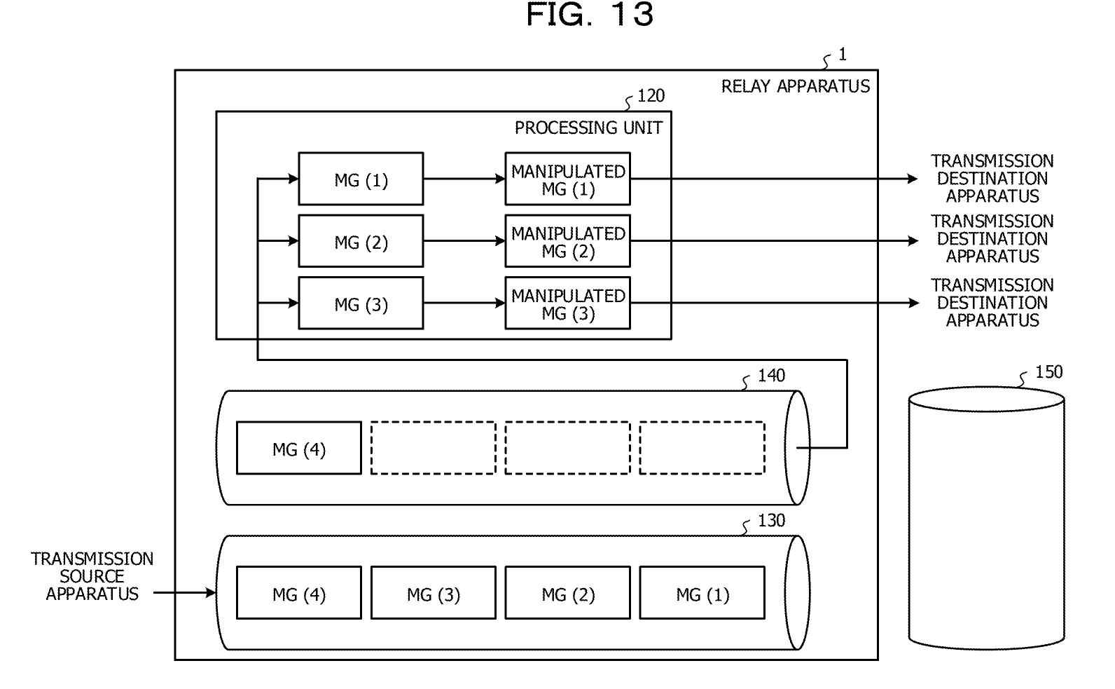

For example, as illustrated in FIG. 13, the relay apparatus 1 extracts MG (1) to MG (3) stored in the information storage area 140. Then, the relay apparatus 1 generates manipulated MG (1) to manipulated MG (3) from extracted MG (1) to MG (3), respectively. Thereafter, the relay apparatus 1 transmits each of generated manipulated MG (1) to manipulated MG (3) to the information processing apparatus 11 of the transmission destination in accordance with the order of reception.

Meanwhile, as represented in FIG. 11, the relay apparatus 1 waits until detecting rollback associated with processing for the message 131 (NO of S11). For example, after generation of the manipulated message 133 of the message 131b and before transmission of the manipulated message 133 to the transmission destination, the relay apparatus 1 waits until rollback of processing for the message 131a (another message 131a) earlier than the message 131b in the order of reception occurs. Then, if detecting rollback (YES of S11), the relay apparatus 1 stores the manipulated message 133 of the message 131b in the information storage area 150 (S12). Furthermore, the relay apparatus 1 associates the identification information 141 of the manipulated message 133 stored in the processing of S12 with the message 131b and stores the identification information 141 in the information storage area 140 (S13).

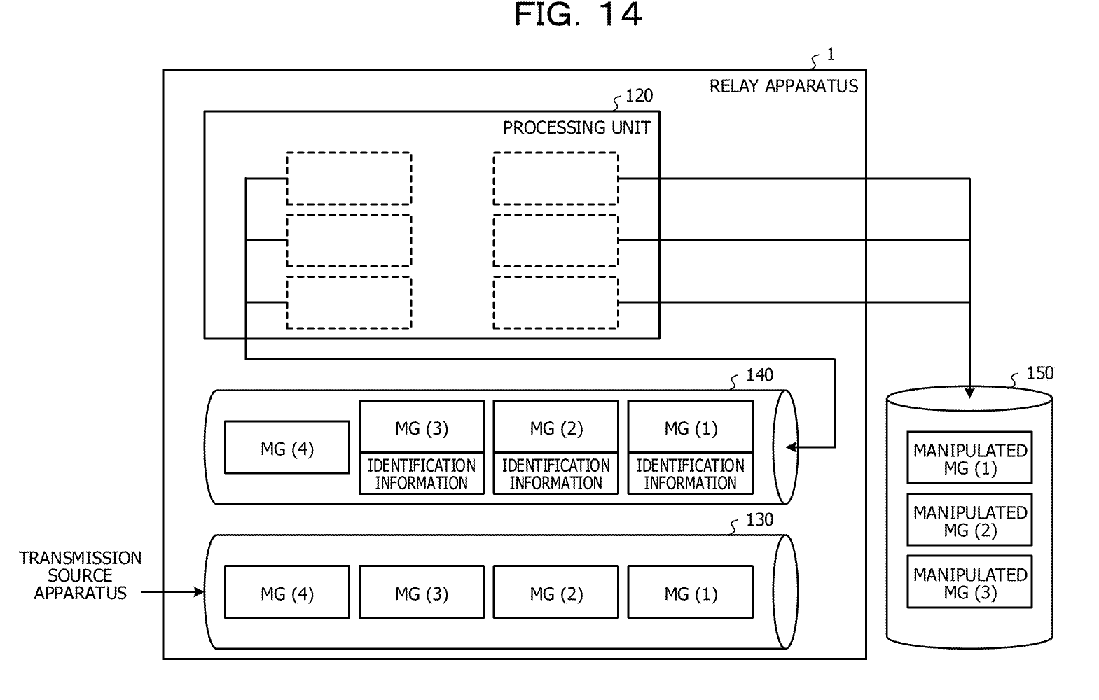

For example, if rollback of MG (1) occurs, the relay apparatus 1 returns MG (2) and MG (3) in addition to MG (1) to the information storage area 140 as illustrated in FIG. 14. Then, in this case, the relay apparatus 1 stores MG (1) to MG (3) in the information storage area 140 in the state in which MG (1) to MG (3) are associated with the identification information 141 of manipulated MG (1) to manipulated MG (3), respectively, that have been already generated. Furthermore, the relay apparatus 1 stores each of manipulated MG (1) to manipulated MG (3) in the information storage area 150 as illustrated in FIG. 14.

Due to this, when extraction of the message 131 returned to the information storage area 140 in association with the occurrence of the rollback is carried out again, the relay apparatus 1 is enabled to identify the manipulated message 133 of the message 131 extracted from the information storage area 140 by referring to the identification information 141. Furthermore, the relay apparatus 1 is enabled to acquire the manipulated message 133 generated from the message 131 extracted from the information storage area 140 among the manipulated messages 133 stored in the information storage area 150 and transmit the manipulated message 133 to the information processing apparatus 11 of the transmission destination. This allows the relay apparatus 1 to keep generation of the same manipulated message 133 from being repeatedly carried out every time rollback occurs.

As above, the relay apparatus 1 in the present embodiment associates plural messages 131 received from the transmission source with the order of reception of each of the plural messages 131 and stores the plural messages 131 in the storing part 140. In addition, the relay apparatus 1 generates the manipulated message 133 of each of the plural messages 131. Then, the relay apparatus 1 transmits each of the generated manipulated messages 133 to the transmission destination in accordance with the order of reception.

Thereafter, after generation of the manipulated message 133 of the message 131b among the plural messages 131 and before transmission of the manipulated message 133, the relay apparatus 1 detects rollback of the message 131a that is associated with earlier order of reception than the message 131b and is stored in the storing part 140. Furthermore, when detecting the rollback, the relay apparatus 1 stores the manipulated message 133 of the message 131b in the storing part 150. In addition, the relay apparatus 1 associates the identification information 141 of the manipulated message 133 of the message 131a with the message 131a and stores the identification information 141 in the storing part 140.

Due to this, the relay apparatus 1 does not have to repeatedly generate the manipulated message 133 every time the message 131 is returned to the queue in association with the occurrence of rollback.

### Details of First Embodiment

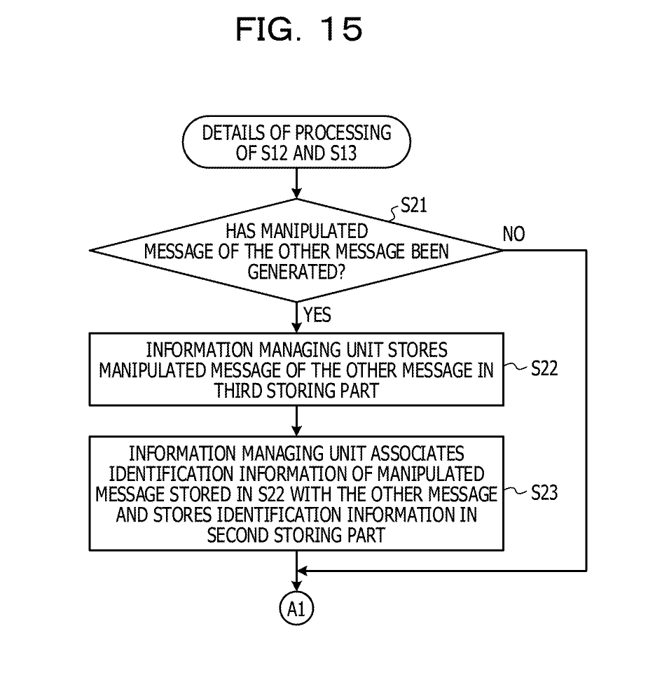

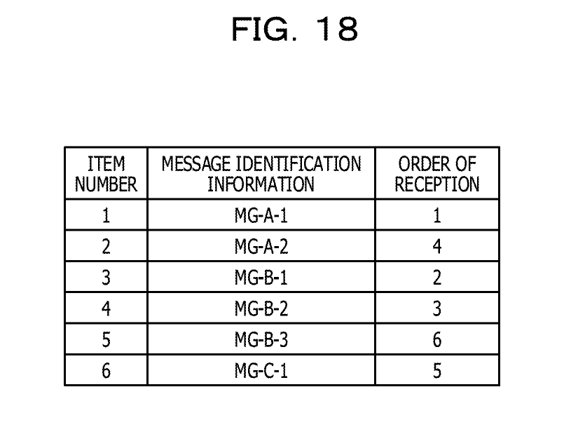

Next, details of the first embodiment will be described. FIG. 15 to FIG. 17 are flowchart diagrams for explaining details of the data management processing in the first embodiment. Furthermore, FIG. 18 to FIG. 21 are diagrams for explaining the details of the data management processing in the first embodiment. The data management processing of FIG. 15 to FIG. 17 will be described with reference to FIG. 18 to FIG. 21.

[Details of Processing of S12 and S13]

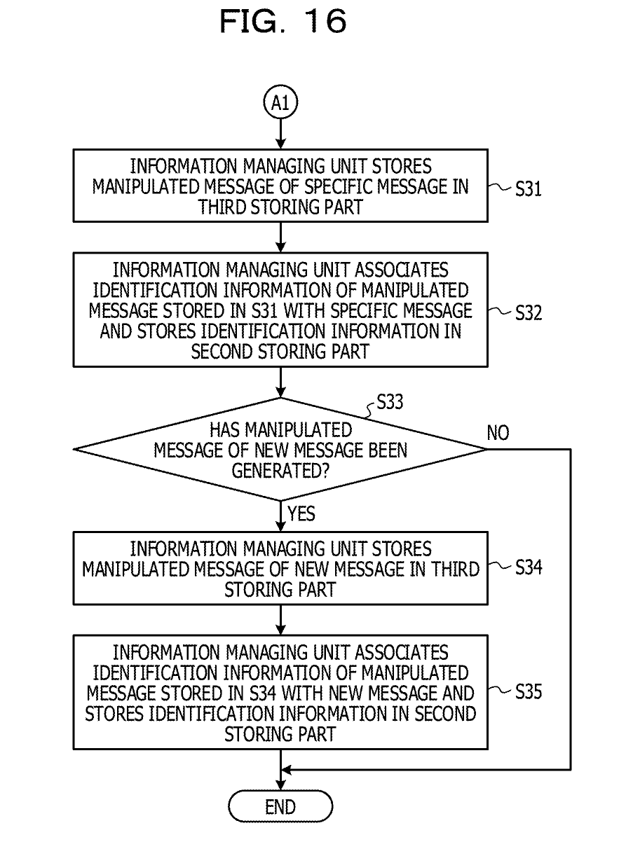

First, details of the processing of S12 and S13 will be described. FIG. 15 and FIG. 16 are diagrams for explaining the details of the processing of S12 and S13.

As described with FIG. 11, the rollback detecting unit 114 waits until detecting rollback associated with processing for the message 131 (NO of S11). For example, the rollback detecting unit 114 waits until detecting rollback of processing for the message 131a that is associated with earlier order of reception than the message 131b and is stored in the information storage area 140 after generation of the manipulated message 133 of the message 131b and before transmission of the manipulated message 133 to the information processing apparatus 11 of the transmission destination.

Then, if rollback is detected (YES of S11), the information managing unit 115 determines whether or not the manipulated message 133 of the message 131a has been generated (S21) as represented in FIG. 15. If the manipulated message 133 of the message 131a has been generated as the result (YES of S21), the information managing unit 115 stores the manipulated message 133 of the message 131a in the information storage area 150 (S22). Furthermore, the information managing unit 115 associates the identification information 141 of the manipulated message 133 stored in the processing of S22 with the message 131a and stores the identification information 141 in the information storage area 140 (S23).

For example, in the case in which rollback of the message 131a is detected, the manipulated message 133 of the message 131a has been already generated in some cases. Thus, if determining that the manipulated message 133 of the message 131a has been already generated, the information managing unit 115 carries out the storing of the identification information 141 that associates the message 131a returned to the information storage area 140 with the manipulated message 133 of the message 131a. Concrete examples of the identification information 141 will be described later.

Subsequently, as represented in FIG. 16, the information managing unit 115 stores the manipulated message 133 of the message 131b in the information storage area 150 (S31). For example, the information managing unit 115 refers to the order-of-reception information 132 stored in the information storage area 140 and stores, in the information storage area 150, the manipulated message 133 of the message 131b later in the order of reception than the message 131a, which is the cause of the occurrence of the rollback.

Then, the information managing unit 115 associates the identification information 141 of the manipulated message 133 of the message 131b stored in the processing of S31 with the message 131b and stores the identification information 141 in the information storage area 140 (S32). A concrete example of the order-of-reception information 132 will be described below.

### Concrete Example of Order-of-Reception Information

FIG. 18 is a diagram for explaining a concrete example of the order-of-reception information 132. The order-of-reception information 132 represented in FIG. 18 includes, as items, “item number” to identify each piece of information included in the order-of-reception information 132, “message identification information” in which message identification information to identify each message 131 is set, and “order of reception” in which the order of reception of each message 131 is set.

For example, in the order-of-reception information 132 represented in FIG. 18, in information whose “item number” is “1,” “MG-A-1” indicating that the relevant message is the first message 131 among the messages 131 transmitted from the information processing apparatus 11a is set as “message identification information.” In addition, in the order-of-reception information 132 represented in FIG. 18, in the information whose “item number” is “1,” “1” indicating that the relevant message is the first message 131 among the messages 131 received by the relay apparatus 1 is set as “order of reception.”

Furthermore, in the order-of-reception information 132 represented in FIG. 18, in information whose “item number” is “5,” “MG-B-3” indicating that the relevant message is the third message 131 among the messages 131 transmitted from the information processing apparatus 11b is set as “message identification information.” In addition, in the order-of-reception information 132 represented in FIG. 18, in the information whose “item number” is “5,” “6” indicating that the relevant message is the sixth message 131 among the messages 131 received by the relay apparatus 1 is set as “order of reception.” Explanation is omitted regarding the other pieces of information included in FIG. 18.

Referring back to FIG. 16, the information managing unit 115 determines whether or not the manipulated message 133 of the new message 131 (hereinafter, referred to also as message 131c) later than the message 131b in the order of reception has been generated in the period until the manipulated message 133 of the message 131a is transmitted (S33). Then, if determining that the manipulated message 133 of the message 131c has been generated (YES of S33), the information managing unit 115 stores the manipulated message 133 of the message 131c in the information storage area 150 (S34). Furthermore, the information managing unit 115 associates the identification information 141 of the manipulated message 133 of the message 131c stored in the processing of S34 with the message 131c and stores the identification information 141 in the information storage area 140 (S35).

For example, even if rollback associated with processing for the message 131a occurs, the message manipulating unit 112 may extract the message 131 from the information storage area 140 and continue generation of the manipulated message 133. For this reason, even before the message 131a is transmitted after the occurrence of rollback associated with processing for the message 131a (for example, before the abnormality as the cause of the rollback is resolved), the manipulated message 133 (manipulated message 133 of the message 131c) is generated in some cases.

Therefore, if the manipulated message 133 of the message 131c is generated, the information managing unit 115 stores the manipulated message 133 of the message 131c in the information storage area 150. Furthermore, the information managing unit 115 stores the identification information 141 that associates the message 131c with the manipulated message 133 of the message 131c in the information storage area 140.

On the other hand, if the manipulated message 133 of the new message 131c is not generated in the period until the manipulated message 133 of the message 131a is transmitted (NO of S33), the information managing unit 115 does not execute the processing of S34 and S35.

The information managing unit 115 may execute the processing of S34 and S35 every time generation of the manipulated message 133 of the message 131c is generated in the period until the manipulated message 133 of the message 131a is transmitted.

[Details of Processing of S3 and S4]

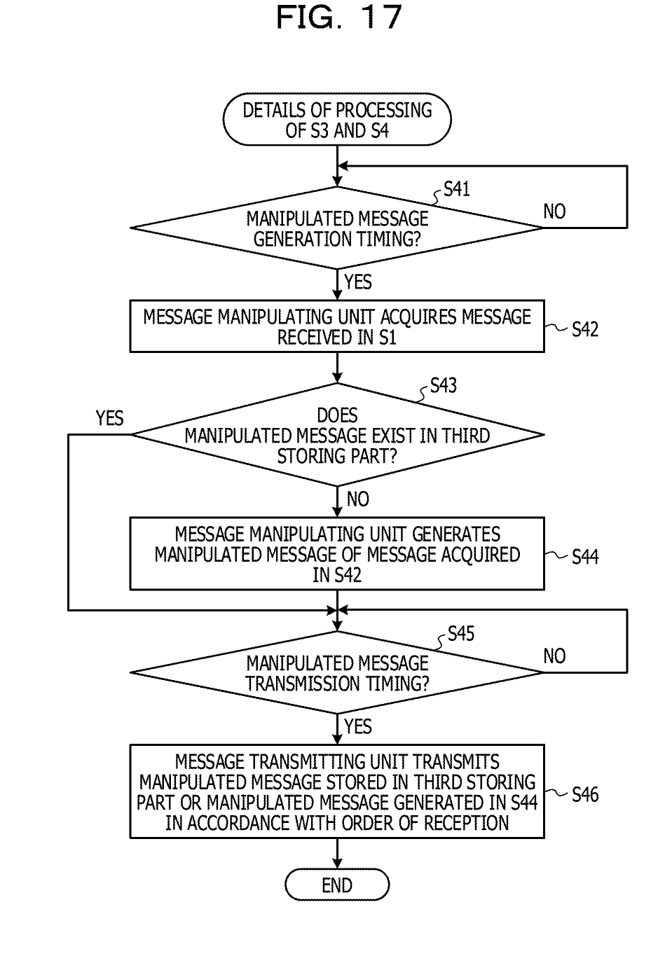

Next, details of the processing of S3 and S4 will be described. FIG. 17 is a diagram for explaining the details of the processing of S3 and S4.

As described with FIG. 10, the message receiving unit 111 waits until receiving the message 131 from the information processing apparatus 11 of the transmission source (NO of S1). Then, if receiving the message 131 (YES of S1), the message receiving unit 111 associates the message 131 received in the processing of S1 with the order of reception of each message 131 and stores the message 131 in the information storage area 140 (S2).

Thereafter, as represented in FIG. 17, the message manipulating unit 112 waits until a manipulated message generation timing (NO of S41). The manipulated message generation timing may be at every given time interval (for example, ten seconds). Furthermore, the manipulated message generation timing may be a timing after the processing of S2 is executed. Moreover, the manipulated message generation timing may be a timing when the number of manipulated messages 133 that are being generated becomes smaller than the maximum number of manipulated messages 133 that may be concurrently generated by the message manipulating unit 112.

Then, if the manipulated message generation timing has come (YES of S41), the message manipulating unit 112 acquires the message 131 received in the processing of S1 (S42). For example, the message manipulating unit 112 acquires the message 131 stored in the information storage area 140 in accordance with the order of reception of the message 131. In the processing of S42, the message manipulating unit 112 may acquire the message 131 until the number of manipulated messages 133 that are being generated becomes the maximum number of manipulated messages 133 that may be concurrently generated, for example.

Thereafter, if the manipulated message 133 of the message 131 acquired in the processing of S42 is not stored in the information storage area 150 (NO of S43), the message manipulating unit 112 generates the manipulated message 133 of the message 131 acquired in the processing of S42 (S44). On the other hand, if the manipulated message 133 of the message 131 acquired in the processing of S42 is stored in the information storage area 150 (YES of S43), the message manipulating unit 112 does not execute the processing of S44.

For example, if rollback associated with processing for the message 131a occurs, the information managing unit 115 stores the manipulated message 133 that has been already generated in the information storage area 150 in the state in which reference to the manipulated message 133 is possible. For this reason, the manipulated message 133 of the message 131 acquired in the processing of S42 is the manipulated message 133 that has been already generated before the rollback is carried out and is stored in the information storage area 150 by the information managing unit 115 in some cases.

Therefore, the message manipulating unit 112 does not generate the manipulated message 133 if the manipulated message 133 of the message 131 acquired in the processing of S42 is stored in the information storage area 150. This allows the message manipulating unit 112 to keep generation of the same manipulated message 133 from being repeatedly carried out in association with the occurrence of rollback.

Then, the message transmitting unit 113 waits until a manipulated message transmission timing (NO of S45). The manipulated message transmission timing may be a timing at which the manipulated message 133 that waits to be transmitted has been stored in the information storage area 150. Furthermore, the manipulated message transmission timing may be a timing after the processing of S44 is executed.

Thereafter, if the manipulated message transmission timing has come (YES of S45), the message transmitting unit 113 transmits the manipulated message 133 stored in the information storage area 150 or the manipulated message 133 generated in the processing of S44 in accordance with the order of reception (S46). For example, if the manipulated message 133 stored in the information storage area 150 exists in the processing of S43, the message transmitting unit 113 transmits the manipulated message 133 stored in the information storage area 150 in addition to the manipulated message 133 generated in the processing of S44. For example, in this case, the message transmitting unit 113 sequentially transmits each of the manipulated messages 133 stored in the information storage area 150 and the manipulated messages 133 generated in the processing of S44 in accordance with the order of reception.

If the manipulated message 133 stored in the information storage area 150 is transmitted to the information processing apparatus 11 of the transmission destination, the information managing unit 115 may delete information corresponding to the transmitted manipulated message 133 in the identification information 141 stored in the information storage area 140. Concrete examples of the identification information 141 will be described below.

### Concrete Examples of Identification Information

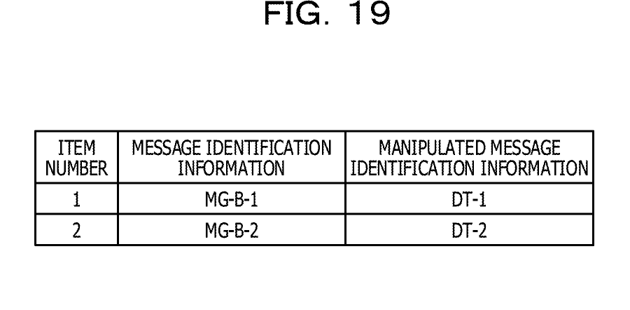

FIG. 19 to FIG. 21 are diagrams for explaining concrete examples of the identification information 141. The identification information 141 illustrated in FIG. 19 to FIG. 21 includes, as items, “item number” to identify each piece of information included in the identification information 141, “message identification information” in which the identification information of each message 131 is set, and “manipulated message identification information” in which the identification information of each manipulated message 133 is set.

First, a concrete example of the identification information 141 when rollback has occurred will be described. FIG. 19 is a diagram for explaining the concrete example of the identification information 141 when rollback has occurred.

The order-of-reception information 132 described with FIG. 18 indicates that the message receiving unit 111 has received the messages 131 in order of MG-A-1, MG-B-1, MG-B-2, MG-A-2, MG-C-1, and MG-B-3. In this case, for example, if rollback occurs due to an abnormality that has occurred in transmission of the manipulated message 133 of MG-B-1, the information managing unit 115 returns MG-B-1 and MG-B-2 to the information storage area 140, for example.

Then, in this case, as represented in FIG. 19, the information managing unit 115 sets “DT-1” that is the identification information of the manipulated message 133 of MG-B-1 in “manipulated message identification information” of the information in which “MG-B-1” is set in “message identification information” (information whose “item number” is “1”). Furthermore, in this case, the information managing unit 115 sets “DT-2” that is the identification information of the manipulated message 133 of MG-B-2 in “manipulated message identification information” of the information in which “MG-B-2” is set in “message identification information” (information whose “item number” is “2”). Due to this, when rollback occurs, the information managing unit 115 may create the identification information 141 for identifying the manipulated message 133 that has been already generated before the occurrence of the rollback.

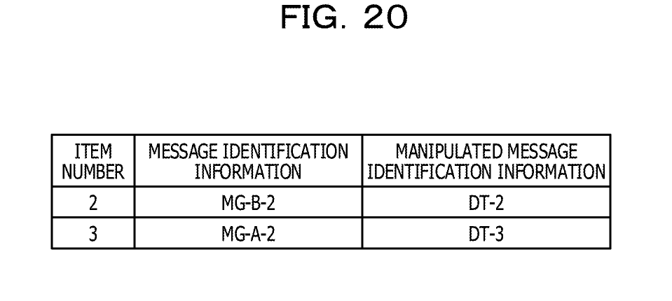

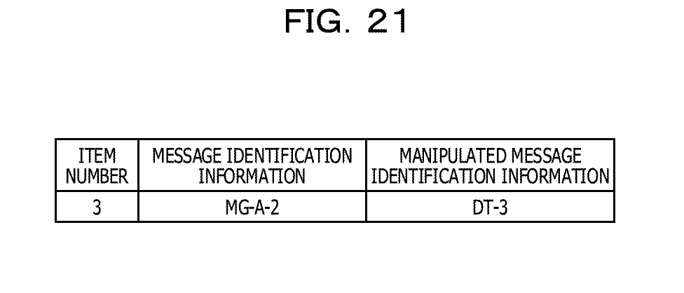

Next, description will be made about concrete examples of the identification information 141 when transmission of the manipulated message 133 of the message 131 as the cause of the occurrence of rollback has been completed, for example, concrete examples of the identification information 141 when the abnormality as the cause of the occurrence of the rollback has been resolved. FIG. 20 and FIG. 21 are diagrams for explaining the concrete examples of the identification information 141 when transmission (retransmission) of the manipulated message of the message as the cause of the occurrence of rollback has been completed.

In this case, the information managing unit 115 deletes the information on the message 131a as the cause of the occurrence of the rollback from the identification information 141. For example, as represented in FIG. 20, the information managing unit 115 deletes the information on MG-B-1, which is the message 131a as the cause of the occurrence of the rollback (information whose “item number” is “1” in FIG. 19).

Furthermore, if the manipulated message 133 of the message 131c is generated in the period after the occurrence of the rollback and until the completion of transmission of the manipulated message as the cause of the occurrence of the rollback, the information managing unit 115 adds the information on the message 131c to the identification information 141. For example, the information managing unit 115 adds the information on MG-A-2 (information whose “item number” is “3” in FIG. 20) as represented in FIG. 20.

Thereafter, every time the manipulated message 133 of the message 131c is transmitted to the information processing apparatus 11 of the transmission destination, the information managing unit 115 deletes the information on the transmitted message 131c from the identification information 141. For example, as represented in FIG. 21, the information managing unit 115 deletes the information on MG-B-2 that is the message 131c transmitted to the information processing apparatus 11 of the transmission destination (information whose “item number” is “2” in FIG. 20).

As above, the relay apparatus 1 in the present embodiment associates plural messages 131 received from the transmission source with the order of reception of each of the plural messages 131 and stores the plural messages 131 in the storing part 140. In addition, the relay apparatus 1 generates the manipulated message 133 of each of the plural messages 131. Then, the relay apparatus 1 transmits each of the generated manipulated messages 133 to the transmission destination in accordance with the order of reception.

Moreover, after generation of the manipulated message 133 of the message 131b among the plural messages 131 and before transmission of the manipulated message 133, the relay apparatus 1 detects rollback of the message 131a that is associated with earlier order of reception than the message 131b and is stored in the storing part 140. Furthermore, when detecting the rollback, the relay apparatus 1 stores the manipulated message 133 of the message 131b in the storing part 150. In addition, the relay apparatus 1 associates the identification information 141 of the manipulated message 133 of the message 131a with the message 131a and stores the identification information 141 in the storing part 140.

Due to this, the relay apparatus 1 does not have to repeatedly generate the manipulated message 133 every time the message 131 is returned to the queue in association with the occurrence of rollback.

### Second Embodiment

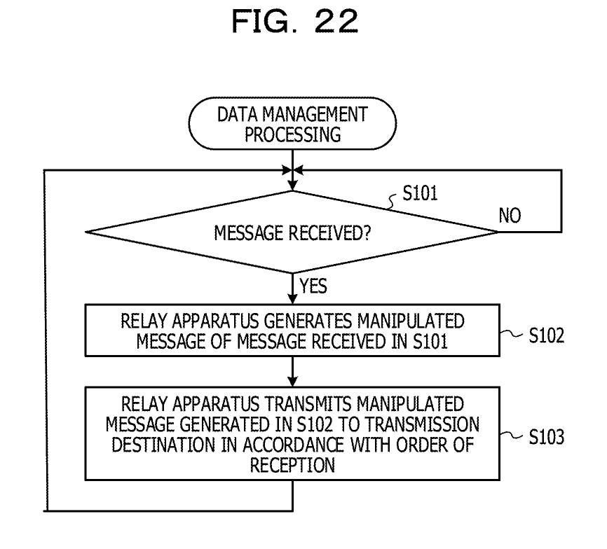

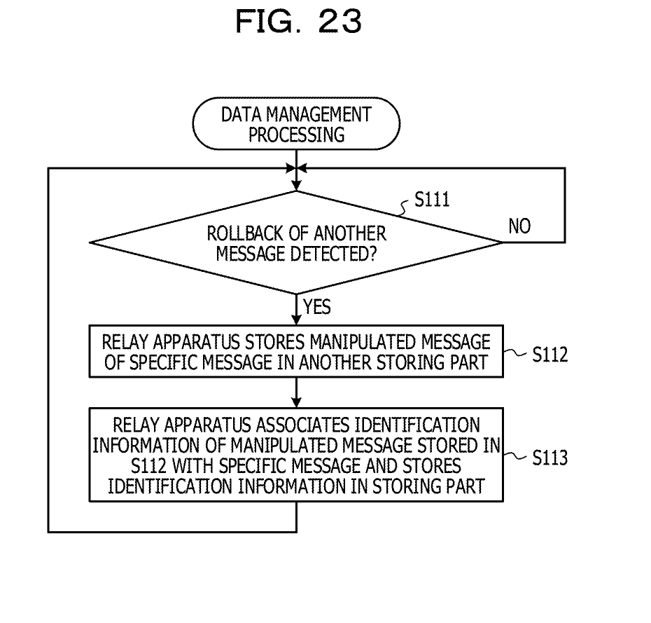

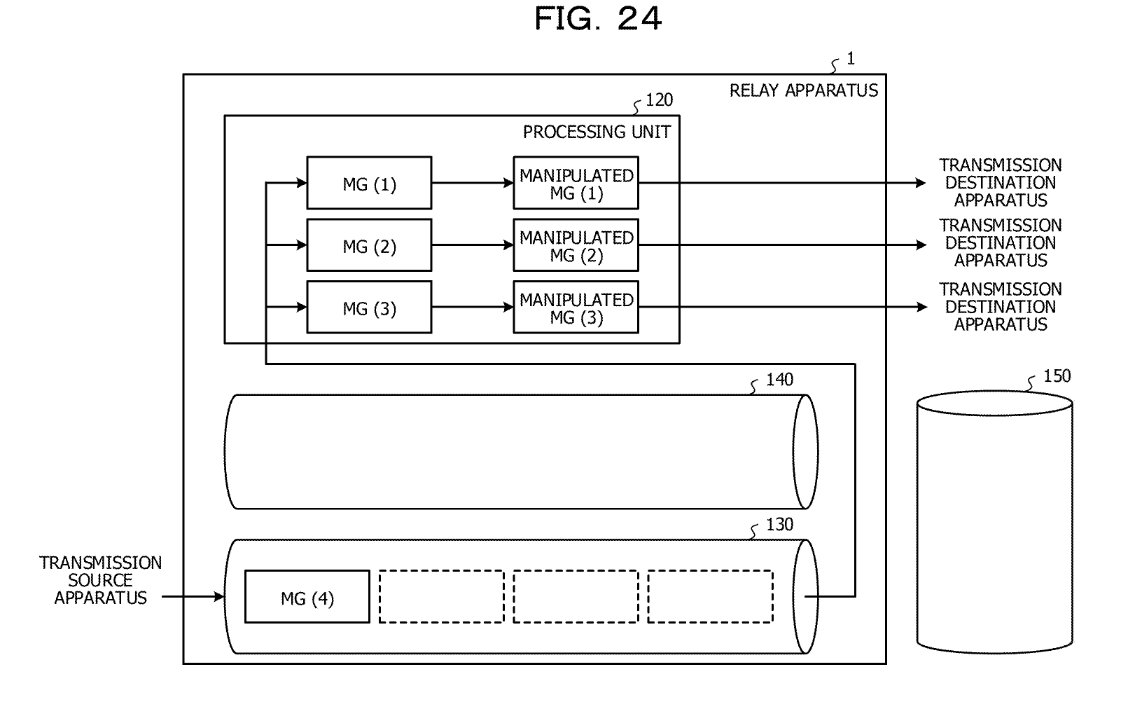

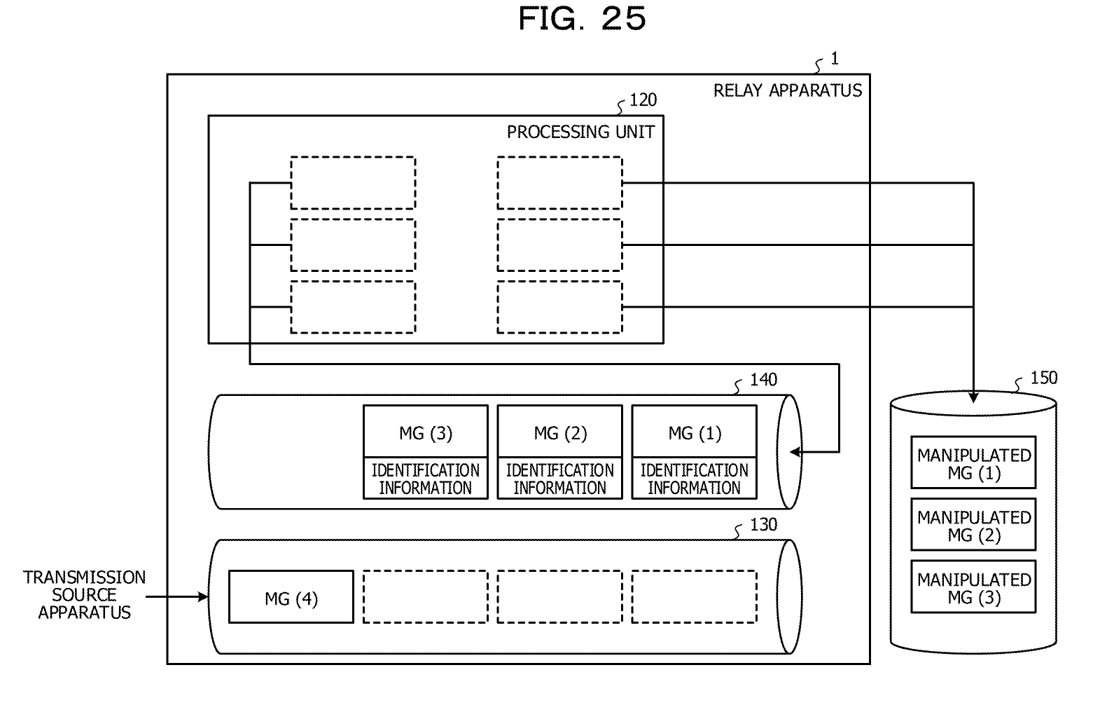

Next, data management processing in a second embodiment will be described. FIG. 22 and FIG. 23 are flowchart diagrams for explaining details of the data management processing in the second embodiment. Furthermore, FIG. 24 and FIG. 25 are diagrams for explaining the details of the data management processing in the second embodiment. The data management processing of FIG. 22 and FIG. 23 will be described with reference to FIG. 24 and FIG. 25.

The relay apparatus 1 in the first embodiment stores a message stored in the information storage area 130 also in the information storage area 140 in response to storing of the message in the information storage area 130. In contrast, the relay apparatus 1 in the second embodiment does not store, in the information storage area 140, the message stored in the information storage area 130. Furthermore, the relay apparatus 1 in the second embodiment extracts the message 131 from the information storage area 130 and carries out manipulation and so forth. Thereafter, if rollback occurs, the relay apparatus 1 in the second embodiment stores the message 131 desired to be returned to the information storage area 140 instead of the information storage area 130.

This allows the relay apparatus 1 in the second embodiment to suppress the amount of data of the messages stored in the information storage area 140. Description will be made below about flowchart diagrams of the data management processing in the second embodiment.

As represented in FIG. 22, the relay apparatus 1 waits until receiving the message 131 from the information processing apparatus 11 of the transmission source (NO of S101). Then, if receiving the message 131 (YES of S101), the relay apparatus 1 generates the manipulated message 133 of the message 131 received in the processing of S101 (S102).

For example, as illustrated in FIG. 24, if MG (1) to MG (4) transmitted from the information processing apparatus 11 are stored in the information storage area 130, the relay apparatus 1 does not store these messages 131 in the information storage area 140. Then, the relay apparatus 1 extracts MG (1), MG (2), and MG (3) stored in the information storage area 130, for example. Thereafter, the relay apparatus 1 generates manipulated MG (1), manipulated MG (2), and manipulated MG (3) from extracted MG (1), MG (2), and MG (3), respectively.

Subsequently, the relay apparatus 1 transmits the manipulated message 133 generated in the processing of S102 to the information processing apparatus 11 of the transmission destination in accordance with the order of reception (S103). For example, as illustrated in FIG. 24, the relay apparatus 1 transmits each of generated manipulated MG (1), manipulated MG (2), and manipulated MG (3) to the information processing apparatus 11 of the transmission destination.

Meanwhile, as represented in FIG. 23, the relay apparatus 1 waits until detecting rollback associated with processing for the message 131a (NO of S111). Then, if detecting rollback (YES of S111), the relay apparatus 1 stores the manipulated message 133 of the message 131b in the information storage area 150 (S112) similarly to the case of the first embodiment. Furthermore, the relay apparatus 1 associates the identification information 141 of the manipulated message 133 stored in the processing of S112 with the message 131b and stores the identification information 141 in the information storage area 140 (S113) similarly to the case of the first embodiment.

For example, if rollback of MG (1) occurs in the case in which manipulated MG (1) to manipulated MG (3) have been already generated as illustrated in FIG. 24, the relay apparatus 1 returns MG (2) and MG (3) in addition to MG (1) to the information storage area 140 instead of the information storage area 130 as illustrated in FIG. 25. Then, in this case, the relay apparatus 1 stores, in the information storage area 140, the identification information 141 that associates each of MG (1) to MG (3) with a respective one of manipulated MG (1) to manipulated MG (3).

Due to this, the relay apparatus 1 in the second embodiment does not have to repeatedly generate the manipulated message 133 every time the message 131 is returned to the queue in association with the occurrence of rollback similarly to the case of the first embodiment. Furthermore, the relay apparatus 1 in the second embodiment is enabled to suppress the amount of data of the messages stored in the information storage area 140.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable storage medium storing a program that causes a computer to execute a process, the process comprising:
storing a first received data and a second received data into a first storage device, the first received data having been received prior to the second received data;
generating a first processed data corresponding to the first received data and a second processed data corresponding to the second received data, the second processed data being to be transmitted to at least one information processing apparatus other than the computer after a transmission of the first processed data;
storing the second processed data into a second storage device when a rollback relating to the first received data is detected in a specified period, the specified period being a period after the second processed data has been generated and before the second processed data is transmitted; and
transmitting the second processed data stored in the second storage device after the rollback has been detected and the first processed data has been transmitted, the second processed data being not regenerated by retrieving the stored second processed data from the second storage device.

2. The non-transitory computer-readable storage medium according to claim 1, wherein
the first received data and the second received data are stored in the first storage device in association with information indicating an order of receptions.

3. The non-transitory computer-readable storage medium according to claim 1, wherein the process further comprises:
storing the first processed data into the first storage device when the first processed data has been generated at a timing of the rollback.

4. The non-transitory computer-readable storage medium according to claim 2, wherein
the first processed data and the second processed data are transmitted in accordance with the order.

5. The non-transitory computer-readable storage medium according to claim 1, wherein
storing the second processed data into the second storage device when the second processed data is generated after the rollback is detected.

6. A data processing apparatus comprising:
a first storage device;
a second storage device; and
a processor coupled to the first storage device and the second storage device, and the processor configured to execute a process, the process comprising:
storing a first received data and a second received data into the first storage device, the first received data having been received prior to the second received data;
generating a first processed data corresponding to the first received data and a second processed data corresponding to the second received data, the second processed data being to be transmitted to at least one information processing apparatus other than the computer after a transmission of the first processed data;
storing the second processed data into the second storage device when a rollback relating to the first received data is detected in a specified period, the specified period being a period after the second processed data has been generated and before the second processed data is transmitted; and
transmitting the second processed data stored in the second storage device after the rollback has been detected and the first processed data has been transmitted, the second processed data being not regenerated by retrieving the stored second processed data from the second storage device.

7. A data processing method executed by a computer, the data processing method comprising:
storing a first received data and a second received data into a first storage device, the first received data having been received prior to the second received data;
generating a first processed data corresponding to the first received data and a second processed data corresponding to the second received data, the second processed data being to be transmitted to at least one information processing apparatus other than the computer after a transmission of the first processed data;
storing the second processed data into a second storage device when a rollback relating to the first received data is detected in a specified period, the specified period being a period after the second processed data has been generated and before the second processed data is transmitted; and
transmitting the second processed data stored in the second storage device after the rollback has been detected and the first processed data has been transmitted, the second processed data being not regenerated by retrieving the stored second processed data from the second storage device.
